(19) United States
(12) Patent Application Publication
(10) Pub. No.: US 2009/0228200 A1
(43) Pub. Date: Sep. 10, 2009

(54) Electronic Device and Navigation Method Using the Same

(75) Inventor: Shih-Chi Yang, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/392,527

(22) Filed: Feb. 25, 2009

(30) Foreign Application Priority Data
Mar. 6, 2008 (TW) 097107947

(51) Int. Cl. G01C 21/00

(52) U.S. Cl. 701/201; 701/200

(57) ABSTRACT

A handheld electronic device and a navigation method using the same are provided. The handheld electronic device includes a calculating unit and a display unit. The calculating unit generates an indication direction according to first geographic location information, second geographic location information, and a reference direction. The display unit is coupled to the first calculating unit and displays the indication direction and the reference direction simultaneously.

### CROSS REFERENCE TO RELATED PATENT APPLICATION

This patent application is based on Taiwan, R.O.C. patent application No. 97107947 filed on Mar. 6, 2008.

### FIELD OF THE INVENTION

The present invention relates to an electronic device, and more particularly, to an electronic device and a navigation method using the same.

### BACKGROUND OF THE INVENTION

Previously, when one is located in an unfamiliar environment, printed maps and street nameplates are common means for one to find one's destination. However, such method is considered rather inconvenient and risky. Suppose when one is located in a foreign country, without proficiency in the foreign language sufficient to fully understand the street nameplates in the foreign language, one may not find the destination according to printed maps and street nameplates.

Therefore, printed maps are gradually replaced by navigation devices. Through route planning by built-in maps, a navigation device displays an electronic map and indication directions for turning left or right, so as to guide a user to an intended destination.

However, the foregoing navigation device is necessarily equipped with a costly high-level processor serving as a map engine for executing route planning. As a result, it is difficult to reduce the manufacturing costs of such navigation devices. Further, to use the navigation device, a consumer may need to additionally purchase high priced electronic maps, which may again dissuade the consumer from making the purchase. In view of the above reasons, it is an object of the invention to provide an economical electronic device with navigation functions enabling a user to quickly and reliably reach a destination.

### SUMMARY OF THE INVENTION

Embodiments of the present invention provide an electronic device capable of displaying indication directions and a method using the same. Based on the indication directions, a user is more easily able to quickly and accurately reach a destination. Apart from lowering manufacturing costs for higher market competitive strength, the invention also provides a user with enhanced conveniences.

The electronic device according to an embodiment of the invention comprises a calculating unit and a display unit. The calculating unit generates an indication direction according to first geographic location information, second geographic location information, and a reference direction. The display unit is coupled to the calculating unit and displays the indication direction and the reference direction simultaneously.

An embodiment of the present invention further provides a navigation method comprising steps of generating an indication direction according to first geographic location information, second geographic location information, and a reference direction; and simultaneously displaying the indication direction and the reference direction.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram according to a first embodiment of the invention.

FIGS. 2 to 4 are partial display images of a display unit 120.

FIG. 5 is a schematic diagram of a destination, a current location and a reference direction.

FIG. 6 is a schematic diagram according to a second embodiment of the invention.

FIG. 7 is a schematic diagram according to a third embodiment of the invention.

FIG. 8 is a flowchart of a navigation method according to an embodiment of the invention.

### DETAILED DESCRIPTION OF THE PREFERRED EMBODIMENT

A handheld electronic device capable of displaying indication directions shall be illustrated in the embodiments below. The handheld electronic device comprises a first calculating unit, and a display unit coupled to the calculating unit. The first calculating unit generates an indication direction according to first geographic location information, second geographic information, and a reference direction. Preferably, the handheld electronic device is suitable for use by pedestrians, and, in one preferred embodiment, a linear distance between a first geographic location and a second geographic location does not exceed a distance traveled by a grown person on foot within a day.

### First Embodiment

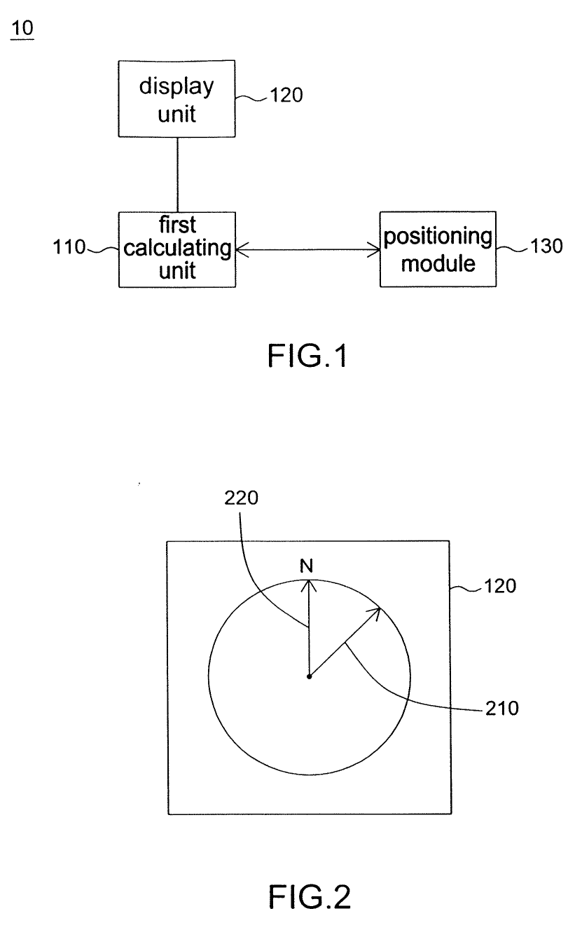

FIG. 1 shows a schematic diagram according to a first embodiment of the invention. A handheld electronic device 10, such as a navigation device or a portable electronic device, comprises at least a first calculating unit 110 and a display unit 120. When the handheld electronic device 10 is a navigation device, the first calculating unit 110 may be a calculating unit of a Global Positioning System (GPS) chip, which further comprises a positioning module 130. That is, the first calculating unit 110 and the positioning module 130 are simultaneously realized by the GPS chip. When the handheld electronic device 10 is a portable electronic device other than a navigation device, e.g., a mobile phone, a PDA or a music player, the first calculating unit 110 may be a processing unit processing baseband signals in the portable electronic device, and the additional positioning module 130 assists the first calculating unit 110 in acquiring needed information. For purposes of simpler illustration, certain modules in the portable electronic device are not depicted, e.g., a transceiver module of a mobile phone.

The first calculating unit 110 controls the positioning module 130 to detect first geographic location information. According to the first geographic location, second geographic location information and a reference direction, the first calculating unit 110 generates an indication direction, which is then displayed on the display unit 120.

The first geographic location information and the second geographic location information are longitude and latitude information of a current location and of a destination, respectively. The second geographic location information may be pre-loaded into a memory (not shown) of the handheld electronic device 10. The reference direction may be associated or not associated with terrestrial magnetism of the earth. When the reference direction is not associated with terrestrial magnetism of the earth, the first calculating unit 110 obtains the reference direction by analyzing positioning information of the positioning module 130. More specifically, when the handheld electronic device 10 is in a mobile state, the positioning module 130 constantly/periodically records geographic location information (longitude and latitude information) of the handheld electronic device 10. The first calculating unit 110 then generates the reference direction by analyzing the geographic location information recorded.

When the first calculating unit 110 and the positioning 130 are simultaneously realized by the GPS chip, the first calculating unit 110 may be a processor in the GPS chip, for example. Since the first calculating unit 110 is merely required to control the positioning module 130 in order to generate the indication direction, such functionality may be realized using a low-level processor in the GPS chip, and no additional processor for assisting in controlling the positioning module 130 is needed.

The first calculating unit 110 may also be realized by a processor in the handheld electronic device 10. Being merely required to control the positioning module 130 in order to generate the indication direction, the first calculating unit 110 can be realized using a low-level processor, and no additional processor for assisting in controlling the positioning module 130 is needed.

The handheld electronic device 10 only needs to generate the indication direction for enabling a user to quickly and accurately reach a destination. Therefore, a costly high-level processor is not necessarily provided in the handheld electronic device 10 to serve as the map engine, thereby significantly lowering manufacturing costs as well as increasing market competitive strength of the handheld electronic device 10. Further, a consumer is not forced to make additional purchases of high priced electronic maps, thereby promoting a consumer's purchase inclination.

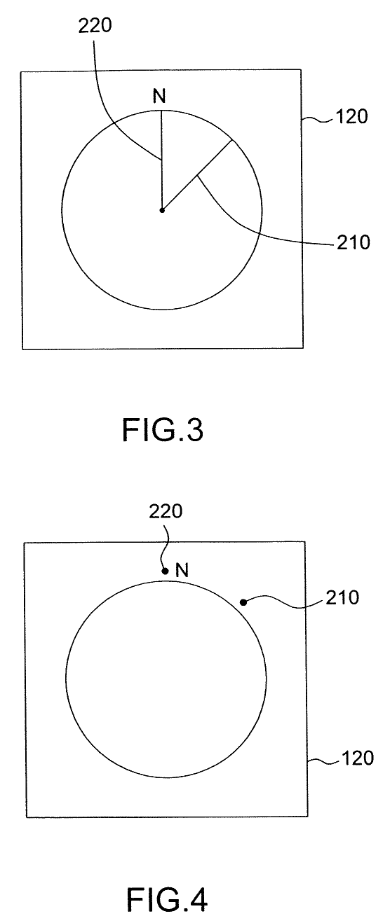

FIGS. 2 to 4 show partial display images of the display unit 120. The indication direction and the reference direction may be presented in different forms. For instance, an indication direction 210 and a reference direction 220 are represented by arrows in FIG. 2, by straight lines in FIG. 3, or by dots in FIG. 4. Or, the indication direction 210 and the reference direction 220 may be represented by a combination of the three patterns above, such as the indication direction 210 is represented by an arrow, and the reference direction 220 is represented by a dot.

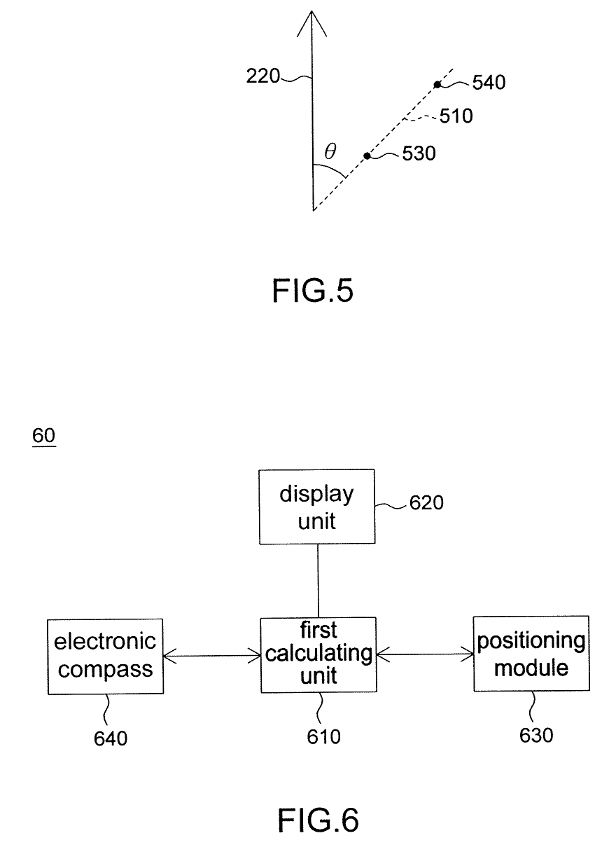

FIG. 5 shows a schematic diagram of a destination, a current location of the handheld electronic device 10, and a reference direction. To go to a destination 540 from a current location 530, the calculating unit 110 as shown in FIG. 1 generates a virtual dotted connecting line according to the longitude and latitude information of the current location 530 and of the destination 540. The virtual dotted connecting line corresponds with a connecting line 510 between the current location 530 and the destination 540. The first calculating unit 110 calculates an included angle θ between the connecting line 510 and the reference direction 220, and then generates the indication direction 210 according to the included angle θ and the reference direction 220 as shown in FIGS. 2 to 4.

In practice, the display images in FIGS. 2 to 4 may be even more simplified. Since a user may obtain bearings of the destination based solely on the indication direction 210, the display images need only show the indication direction 210 but not the reference direction 220. The reference direction 220 is then shown when the user needs.

### Second Embodiment

FIG. 6 shows a schematic diagram according to a second embodiment of the invention. A difference between the present embodiment and the first embodiment is that, a handheld electronic device 60 according to the present embodiment further comprises an electronic compass 640. Associated principles and operations of a first calculating unit 610, a display unit 620 and a positioning module 630 of the handheld electronic device 60 are similar to those of the first calculating unit 110, the display unit 120 and the positioning module 130 in the first embodiment, and shall not be unnecessarily further described.

In this embodiment, the reference direction is associated with terrestrial magnetism of the earth; that is, the reference direction of the handheld electronic device 60 is provided by the electronic compass 640. The electronic compass 640 detects the north of the earth, and sends information corresponding to the north (reference direction) to the first calculating unit 610. The first calculating unit 610 then generates the indication direction according to the first geographic information, the second geographic information and the reference direction.

### Third Embodiment

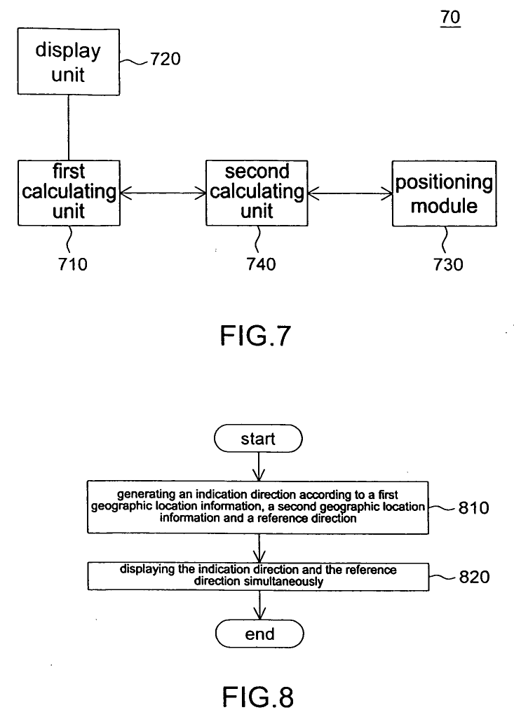

FIG. 7 shows a schematic diagram according to a third embodiment of the invention. A handheld electronic device 70 further comprises a second calculating unit 740, and may be an electronic device such as a mobile phone, a PDA or a music player. For purposes of simpler illustration, certain modules are not depicted, e.g., a transceiver module in a mobile phone. In the handheld electronic device 70, a first calculating unit 710 serves as a processor for processing baseband signals. Associated principles and operations of other components such as a display unit 720 and a positioning module 730 are similar to those of the aforesaid display unit 120 and the positioning module 130, and shall not be unnecessarily further described. A difference between the third embodiment and the first embodiment is that, the handheld electronic device 70 further comprises a second calculating unit 740 for controlling the positioning module 730 in order to detect first geographic information. Preferably, the positioning module 730 and the second calculating unit 710 are realized by a GPS chip. Since the first calculating unit 710 is not required to control the positioning module 730, this embodiment further reduces operation loading of the first calculating unit 710 compared to that in the first embodiment.

### Navigation Method

Embodiments of the invention further provide a navigation method. FIG. 8 shows a flowchart of a navigation method according to an embodiment of the invention. The navigation method may be implemented on the handheld electronic device according to the first to the third embodiments described previously, and the handheld electronic device 10 in the first embodiment shall be used for illustration. The navigation method according to the invention comprises steps of the first calculating unit 110 (FIG. 1) generating the indication direction 210 according to the first geographic location information, the second geographic location information and the reference direction 220 (FIGS. 2 to 4) in Step 810; and the display unit 120 (in FIG. 1) displaying the indication direction 210 and the reference direction 220 simultaneously in Step 820.

The electronic device and navigation method according to the various embodiments of the invention at least provide advantages of: a) providing convenience by enabling a user to quickly and accurately reach a destination; b) significantly lowering manufacturing costs and increasing market competitive strength by not necessarily providing a costly high-level processor serving as a map engine; and c) substantially promoting consumer purchase inclination by eliminating additional purchases of high priced electronic maps.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An electronic device, comprising:
a calculating unit, for generating an indication direction according to first geographic location information, second geographic location information, and a reference direction; and
a display unit, coupled to the calculating unit, for simultaneously displaying the indication direction and the reference direction.

2. The electronic device as claimed in claim 1, wherein the calculating unit produces a connecting line according to the first geographic location information and the second geographic location information, and calculates an included angle between the connecting line and the reference direction, with the indication direction being generated according to the included angle and the reference direction.

3. The electronic device as claimed in claim 1, wherein the first geographic location information is longitude and latitude information of a current location of the electronic device, and the second geographic location information is longitude and latitude information of a destination.

4. The electronic device as claimed in claim 1, further comprising a positioning module for detecting the first geographic location information.

5. The electronic device as claimed in claim 4, wherein the calculating unit controls the positioning module so as to detect the first geographic location information.

6. The electronic device as claimed in claim 4, further comprising another calculating unit for controlling the positioning module so as to detect the first geographic location information.

7. The electronic device as claimed in claim 6, wherein the positioning module and said another calculating unit are realized by a Global Positioning System (GPS) chip.

8. The electronic device as claimed in claim 1, wherein the reference direction is associated with terrestrial magnetism of the earth.

9. The electronic device as claimed in claim 8, further comprising an electronic compass for providing the reference direction.

10. The electronic device as claimed in claim 1, further comprising:
a positioning module, for detecting geographic location information;
wherein, the calculating unit provides the reference direction according to the geographic location information.

11. The electronic device as claimed in claim 1, being a navigation device.

12. The electronic device as claimed in claim 1, being a handheld electronic device.

13. A navigation method, comprising steps of:
generating an indication direction according to first geographic location information, second geographic location information, and a reference direction; and
simultaneously displaying the indication direction and the reference direction.

14. The navigation method as claimed in claim 13, further comprising:
producing a connecting line according to the first geographic location information and the second geographic location information, calculating an included angle between the connecting line and the reference direction, and generating the indication direction according to the included angle and the reference direction.

15. The navigation method as claimed in claim 13, the method for use in a handheld electronic device, wherein the first geographic location information is longitude and latitude information of a current location of the handheld electronic device, and the second geographic location information is longitude and latitude information of a destination.

16. The navigation method as claimed in claim 13, further comprising detecting first geographic location information.

17. The navigation method as claimed in claim 13, wherein the reference direction is obtained via an electronic compass.

18. The navigation method as claimed in claim 13, wherein the reference direction is obtained according to geographic location information detected by a positioning module.

19. The navigation method as claimed in claim 18, wherein the positioning module is provided in a Global Positioning System (GPS) chip.

20. The navigation method as claimed in claim 13, the method for use in a handheld electronic device, wherein the indication direction is generated by a calculating unit of the handheld electronic device.
